(19) United States
(12) Patent Application Publication
(10) Pub. No.: US 2026/0081859 A1
(43) Pub. Date: Mar. 19, 2026

(54) REMOTE LINK FAILURE MANAGEMENT ENGINE IN AN ARTIFICIAL INTELLIGENCE BACKEND NETWORK SYSTEM

(71) Applicant: Microsoft Technology Licensing, LLC, Redmond, WA (US)

(72) Inventor: Prashant RANJAN, San Jose, CA (US)

(21) Appl. No.: 18/890,163

(22) Filed: Sep. 19, 2024

(51) Int. Cl. H04L 43/10; H04L 41/0681

(52) U.S. Cl. CPC H04L 43/10; H04L 41/0681

(57) ABSTRACT

Methods, systems, and devices for providing remote link failure management using a remote link failure management engine of an artificial intelligence (AI) backend network system are described. Remote link failure management includes hardware-based techniques associated with AI hardware (e.g., an AI accelerator or AI System on Chip “SoC) where the techniques are employed to address malfunctions or breakdowns in components that facilitate the connectivity and communication between AI hardware and other components. The remote link failure management engine supports detecting, mitigating, and recovering from failures in the ports and links in AI hardware. In particular, remote link failure management can be provided for AI hardware based on an Artificial Intelligence Transport Layer Protocol (ATL). ATL enables adding a health bit in ATL data and ACK packets to exchange local port health status between a Sender device and a Receiver device, where the device is artificial intelligence Network Interface Controller (ANC).

### BACKGROUND

Users rely on electronic devices (e.g., computing devices with applications and services) to perform different types of tasks. Computing systems use artificial intelligence (AI) to enhance functionality, efficiency, and capabilities across numerous applications and services. Computing systems use AI to automate tasks, analyze data, personalize user experiences, and enable advance functionality across various domains. Computing systems may be integrated with AI accelerators or AI System on Chip (SoCs) that provide necessary specialized hardware to handle demanding computations of AI tasks efficiently. For example, Graphics Processing Units (GPUs), Tensor Processing Units (TPUs), Field-Programmable Gate Arrays (FPGAs), Application-Specific Integrated Circuits (ASICs), Neural Processing Units (NPUs) can be provided as AI hardware to speed up specific computations (e.g., processing large datasets and complex algorithms used in AI and machine learning) to enhance overall performance and efficiency of computing systems.

### SUMMARY

Various aspects of the technology described herein are generally directed to systems, methods, and devices for, among other things, providing remote link failure management using a remote link failure management engine of an artificial intelligence (AI) backend network system. Remote link failure management can refer to hardware-based techniques associated with AI hardware (e.g., an AI accelerator or AI System on Chip “SoC”), where the techniques and mechanisms are employed to address malfunctions or breakdowns in components that facilitate the connectivity and communication between AI hardware and other components.

The remote link failure management engine supports detecting, mitigating, and recovering from failures in the ports and links in AI hardware. In particular, remote link failure management can be provided for AI hardware based on an Artificial Intelligence Transport Layer Protocol (ATL). ATL enables adding a health bit in ATL data and ACK packets to exchange local port health status between a Sender device and a Receiver device, where the device is artificial intelligence Network Interface Controller (ANC). Remote link failure management can specifically be associated with remote links or ports that provide a connection between two devices that are not physically adjacent or locally connected. Two AI hardware devices may communicate via a remote link and port, where the AI hardware devices are not physically close to each other but are connected over a network.

The AI hardware can include a Network Controller Processor (NCP) that manages communication operations of the AI hardware, an AI Network-Interface Controller (ANC) that is a multi-port controller, an ANC sync that is a composite connection of multiple ANCs that operate together, and a Composite Connection Processor (CCP) that manages the ANC sync. The remote link failure management engine supports detecting, mitigating, and recovering from failures in remote ports and links associated with the AI hardware. In particular, the remote link failure management engine provides a hardware-based Transport Layer Protocol (i.e., an Artificial Intelligence Transport Layer Protocol) that is fast and operates based on minimum firmware and software intervention, thus improving reliability and the AI backend network system.

AI supercomputers operate based on specialized AI accelerators and AI SoCs (collectively “AI hardware”), which are AI hardware components engineered specifically for accelerating AI workloads. The AI hardware facilitate the rapid execution of complex neural network computations, thereby enhancing the performance and efficiency of AI tasks. An AI backend network system can refer to an interconnected fabric that binds AI hardware into a cohesive computation unit. The AI backend network system can have a network architecture designed to accommodate massive data transfer requirement inherent in AI workloads, while simultaneously ensuring low latency and high bandwidth.

Conventional AI backend network systems are not configured with logic and infrastructure for adequate and efficient remote link failure management for AI hardware. The scale and complexity of these AI backend network systems amplify the likelihood of component failures, ranging from individual AI accelerators or AI SoCs to the cables and switches that comprise the AI backend network system. The intricate nature of these failures necessitates manual intervention for diagnosis and repair, which not only disrupts ongoing operations but also introduces significant overhead in terms of operational expenses and system downtime. As such, a remote link failure management solution can be developed to ensure continuous operation, performance optimization, fault tolerance, operational efficiency, and customer satisfaction.

A technical solution—to the limitations of conventional failure recovery management systems—can include providing remote link failure management resources via a remote link failure management engine that supports remote link failure management in an AI backend network system. Remote link failure management can be provided for AI hardware based on an Artificial Intelligence Transport Layer Protocol (ATL) that establishes a set of rules, conventions, and standards that define a format, sequence, and meaning of data exchanged between devices or systems. The rules govern various aspects of communication, such as addressing, data encoding, error detection and correction, timing, and flow control. By adhering to the protocol's specification, devices can interact with each other in a consistent and interoperable manner, ensuring reliable communication across networks. In particular, ATL enables adding a health bit (e.g., 4 bits for 4 ports) in ATL data and ACK packets to exchange local port health status between a Sender ANC and a Receiver ANC.

An ACK packet, short for acknowledgment packet, is a type of data packet sent by a receiving device to confirm the successful receipt of a transmitted packet from a sending device. It serves as a form of feedback, informing the sender that the data transmission was received without errors.

A port health bit can refer to a binary flag that indicates the operational status and health condition of a port. The port health bit can be used to signify whether the port and/or link associated with the port is functioning correctly (healthy) or experiencing issues (unhealthy), such as link failures, errors, or excessive congestion.

A port health status refers to the current operational state and condition of a network port. It indicates whether the port is functioning properly or experiencing issues that may affect its performance or connectivity. The port health status can be carried in one hot-encoded format (e.g., a bit per port). A hot-encoded format can for a packet can refer to a method of structuring data within a network packet where specific bits or fields represent binary states or flags indicating the presence or absence of certain features, options, or characteristics.

Port Status Table (PST) refers to a record or listing that provides information about the status of various ports associated with an ANC. The Port Status Table maintains statuses for ports that are remote from an ANC. The Port Status Table can also maintain both statuses for local ports and remote ports for a Sender ANC and a Remote ANC (e.g., Sender-Local, Sender-Remote, Receiver-Local, and Receive-Remote).

As such, in case a link and/or port failure at a Receiver device (e.g., ANC), the Receiver device can communicate an indication to a Sender device (e.g., ANC) using a field associated with the health bit in the ACK. ACK can be communicated back using an operational link and port of the Receiver device. Sender device upon receiving the ACK can read the bit via the field and update its PST for remote ports. The Sender device, based on updating the PST, can exclude the port because of the failed link and/or port, and perform operations based on the port being constructively deactivated via its status in the PST. As such, the remote link failure management engine and remote link failure management resources can provide an integrated failure management scheme that will improve reliability of AI backend network systems.

In operation, in a first embodiment, a data packet is communicated from a Sender artificial intelligence Network Interface Controller (ANC) to a Receiver ANC. Based on communicating the data packet, an acknowledgement packet that indicates a port health status of a first receiver port of a plurality of receiver ports at the Receiver ANC is received at the Sender ANC. The port health status indicates that the first receiver port has been deactivated at the Receiver ANC. Based on the port health status indicating that the first receiver port has been deactivated at the Receiver ANC, a Sender Port Status Table that maintains port health statuses associated with the plurality of receiver ports at the Receiver ANC is accessed. The Sender Port Status Table is updated with the port health status of the first remote port, where the port health status of the first remote port in the Sender Port Status Table indicates that first remote port has been deactivated. Distribution of workloads for the Receiver ANC via a plurality of sender ports of the Sender ANC is caused based on the Sender Port Status Table.

In a second embodiment, a link status that indicates a link failure condition associated with a first receiver port of a plurality of receiver ports at the Receiver ANC is accessed at a Receiver artificial intelligence Network Interface Controller (ANC). Based on the link status, a Receiver ANC Port Status Table that maintains port health status associated with the plurality of receiver ports at the Receiver ANC is accessed. The Receiver ANC Port Status Table is updated with a port health status of the first receiver port, where the port health status of the first remote port indicates that the first receiver port has been deactivated. A data packet from a Sender ANC is received at a Receiver ANC. Based on the port health status of the first receiver port and the data packet an acknowledgement packet that indicates the port health status of the first receiver port at the Receiver ANC is communicated to the Sender ANC. The acknowledgement packet is communicated to cause the Sender ANC to update a Sender ANC Port Status Table.

In a third embodiment, an artificial intelligence hardware system is provided. The AI hardware system includes a Sender AI Network Interface Controller (ANC), the Sender ANC is a multi-port controller operationally coupled to a plurality of sender ports and corresponding links. The Sender ANC maintains a Sender Port Status Table that maintains port health statuses for the plurality of sender ports and a plurality of receiver ports. The AI hardware system further includes a Receiver ANC, the Receiver ANC is a multi-port controller operationally coupled to the plurality of receiver ports and corresponding links. The Receiver ANC maintains a Receiver Port Status Table that maintains port health statuses for the plurality of receiver ports and the plurality of sender ports.

### BRIEF DESCRIPTION OF THE DRAWINGS

The technology described herein is described in detail below with reference to the attached drawing figures, wherein:

FIGS. 1A-1D are block diagrams of an exemplary AI backend network system including a remote link failure management engine, in accordance with aspects of the technology described herein;

FIG. 2 is a block diagram of an exemplary AI backend network system including a remote link failure management engine, in accordance with aspects of the technology described herein;

FIG. 3 provides a first exemplary method of providing remote link failure management using a remote link failure management engine, in accordance with aspects of the technology described herein;

FIG. 4 provides a second exemplary method of providing remote link failure management using a remote link failure management engine, in accordance with aspects of the technology described herein;

FIG. 5 provides a third exemplary method of providing remote link failure management using a remote link failure management engine, in accordance with aspects of the technology described herein;

FIG. 6 provides a block diagram of an exemplary AI backend network system suitable for use in implementing aspects of the technology described herein;

FIG. 7 provides a block diagram of an exemplary distributed computing environment suitable for use in implementing aspects of the technology described herein; and

FIG. 8 provides a block diagram of an exemplary computing environment suitable for use in implementing aspects of the technology described herein.

### DETAILED DESCRIPTION

### Overview

In designing artificial intelligence (AI) supercomputers, the integration of numerous AI accelerators and AI System on Chip (“SoCs”) (collectively “AI hardware”) interconnected to efficiently execute AI workloads (both Inference and Training) is important. AI supercomputers are evolving to encompass unprecedented scales, potentially comprising hundreds of thousands of AI hardware interconnected via a sophisticated network infrastructure, often referred to as the backend network.

One of the central challenges encountered in the construction of such systems is ensuring reliability. The sheer magnitude of components and cables employed at this scale introduces an increased susceptibility to random failures. These failures, occurring throughout the network, require manual intervention for resolution, which entails halting ongoing operations, transferring tasks to operational nodes, and subsequently restarting them. Consequently, this process incurs substantial operational costs and undermines the overall Total Cost of Ownership (TCO) and performance of the system.

Conventional AI backend network systems are not configured with logic and infrastructure for adequate and efficient remote link failure management for AI hardware. The scale and complexity of these AI backend network systems amplify the likelihood of component failures, ranging from individual AI accelerators or AI SoCs to the cables and switches that comprise the AI backend network system. The intricate nature of these failures necessitates manual intervention for diagnosis and repair, which not only disrupts ongoing operations but also introduces significant overhead in terms of operational expenses and system downtime. Moreover, the implications of reliability extend beyond mere maintenance efforts. The interruptions caused by these failures can lead to substantial productivity losses, especially in scenarios where critical AI tasks are time-sensitive or require uninterrupted processing. Additionally, the need to redistribute workloads among functioning nodes introduces inefficiencies and can potentially bottleneck system performance. As such, a remote link failure management solution can be developed to ensure continuous operation, performance optimization, fault tolerance, operational efficiency, and customer satisfaction.

Moreover, detecting link or port failures in a remote connection context where devices or components are not locally connected presents several challenges. One major issue is the inability to physically inspect the hardware, which makes it harder to identify issues such as loose cables, physical damage, or LED indicator status. Troubleshooting becomes reliant on remote diagnostic tools and protocols like SNMP (Simple Network Management Protocol) or remote access solutions, which may not always provide real-time or detailed information. Another challenge is the potential for network latency or communication issues between the monitoring system and the remote device, affecting the accuracy and timeliness of fault detection. This can lead to delays in identifying and responding to failures, impacting service availability and user experience. Remote environments may also lack redundant paths or alternate connectivity options, limiting failover capabilities and prolonging downtime.

Ensuring adequate monitoring and alerting configurations is important but can be complex due to varying network architectures and device capabilities across different locations. For example, in a one-hop scenario, reliance on remote monitoring tools and protocols like SNMP can be hindered by potential delays in receiving real-time updates or alerts. In a multi-hop context, the complexity increases as failures can occur at any intermediary device along the path, requiring comprehensive monitoring across multiple points to accurately pinpoint and address issues. Implementing failure management strategies is essential to mitigate these challenges and maintain operational continuity.

Software-based solutions for networking failures, while flexible and versatile, have several limitations that can impact performance, reliability, and security. They introduce performance overhead by consuming CPU resources and adding latency, depend heavily on the stability and specific implementation of the operating system, and lack the fine-grained control over hardware components that hardware-based solutions possess. These solutions can be complex to configure and maintain, requiring regular updates and expertise. Additionally, they may have a limited scope of recovery, struggling with specific types of failures or scalability issues in large environments. Consequently, while they offer advantages in flexibility and deployment, their limitations necessitate consideration of hardware-based solutions for robust and efficient failure recovery in critical applications. As such, the remote link failure management system and remote link failure management resources can provide an integrated failure management scheme that will improve reliability of AI backend network systems.

### Description of Technical Solution

At a high level, hardware-based remote link failure management can be provided for a remote link failure management engine associated with an AI hardware (e.g., AI accelerator or AI SoC). An AI accelerator is a specialized hardware component designed to enhance the performance of artificial intelligence (AI) tasks. AI accelerators are optimized for handling the computations and algorithms involved in AI and machine learning tasks more efficiently than traditional central processing units (CPUs) or graphics processing units (GPUs). An AI SoC is a specialized integrated circuit (IC) or chip designed specifically to perform AI tasks directly on the hardware level. While both AI SoCs and AI accelerators are designed to enhance AI processing capabilities, AI SoCs may offer broader, system-level solution suitable for a wide range of applications, integrating multiple components to handle both general and AI-specific tasks. AI accelerators, on the other hand, can be specialized components focused solely on boosting AI performance, often used in conjunction with other system components to offload and accelerate AI workloads.

The AI hardware can include a plurality of ANCs. An ANC manages and facilitates network communication between the AI hardware and other devices or systems. The ANC handles data packets, manages network protocols, and ensures efficient and reliable data transfer to support various function of the AI hardware. The ANC can specifically be a multi-port controller that supports different multi-port modes (e.g., 2 port mode or 4 port modes). The ports can support different data rates, and specifically different data rates in different modes. For example, 2 port mode can include 2 200G ports and 4 port mode can include 4 100G ports. Other variations and combinations of multi-port configurations are contemplated.

Each port is associated with a link to facilitate data transfer in the AI hardware. A port serves as a physical or logical interface through which data enters or exits the AI hardware, encompassing various types such as input/output (I/O) ports, memory ports, or specialized connections to peripherals. The link denotes the communication pathway established between two ports, whether physical connections like wires or logical connections via on-chip communication protocols. Together, ports and links enable the seamless transmission of data into, out of, or between the AI hardware, facilitating coordinated operation and data exchange between different components or modules.

The AI hardware is designed with a port, serving as an interface to connect within the AI hardware or with external devices or networks, and a link representing the established connection. The link encompasses the physical connection (cables, connectors) as well as the logical communication pathway. Port failure could arise from various factors including physical damage caused by mishandling or environmental factors like moisture, heat, or dust, electrical degradation over time, manufacturing defects, or corrosion in humid or corrosive environments. Similarly, link failure might result from cable damage due to bending or wear, electromagnetic interference from nearby devices, protocol incompatibility, or network congestion. A port failure also results in a link failure.

In the event of either port or link failure, the AI hardware employs internal diagnostics to promptly detect the issue and communicates a link status indicating a link failure through error messages. For example, the AI hardware may determine port or link failure via an ANC. The determination of link or port failure can be managed by built-in self-test (BIST) mechanisms and internal monitoring circuits. These BIST functionalities, inherent to the AI hardware design, autonomously execute diagnostic routines during, systematically probing the integrity of internal links and ports. By sending test signals and scrutinizing responses, deviations from expected behavior, such as abnormal signal propagation delays or error rates, are swiftly identified as potential indicators of failure. Additionally, dedicated internal monitoring circuits continuously oversee the status of these interconnects, discerning anomalies such as signal attenuation or loss of integrity.

In one embodiment, the ANC monitoring circuits that continuously monitor the status of internal links and ports. These circuits can detect anomalies such as signal attenuation, excessive noise, or loss of signal integrity, which may signify potential failures. Upon detecting a port or link failure, the ANC communicate a link status indicating a link failure condition with an associated port. In another embodiment, a link failure detection circuit can report the status of a link. By way of illustration, a link is associated with a link failure detection circuit that is an electronic circuit designed to monitor the status of a communication link and detect potential failures or abnormalities. The link failure detection circuit may include specialized electronic components such as sensor circuits, comparators, logic gates, and flip-flops. These components monitor the parameters of communication links, compare them against predefined thresholds, and generate output signals indicating the link status. Register bits store this information within the control registers. The link detection circuit operates with register bits and monitors and manages the status of communication links within the using register bits as indicators or flags. The link failure detection circuit continuously monitors the performance and activity of individual links, updating corresponding register bits to reflect their status. These register bits act as indicators of link health, signaling whether a link is active, idle, or experiencing errors. Register bits, within hardware registers, store and manage essential data and control information that dictate the behaviors of the ANC and NCP.

In the event of a port or link failure, the remote link failure management engine excludes the associated port from packet distribution. Packet transmission will persist via the remaining operational ports and links, with bandwidth adjustments (e.g., updates to bandwidth distribution configuration via the NCP) made to align with the reduced capacity, mitigating credit overflow or backpressure throughout the network path associated with a composite connection (i.e., ANC sync). These bandwidth adjustments will be executed with minimal reliance on firmware or software intervention.

Hardware-based remote link failure management provides a mechanism of recovering from link failures of local and remote links in a hardware-based Transport Layer Protocol (i.e., AI Transport Layer Protocol “ATL”), which is not only faster but requires minimum firmware and software intervention and hence can improve reliability of the overall AI backend network system because jobs are not moved or manual intervention need to address link failures. The remote link failure management engine can be associated with a plurality of ANCs. Each ANC can be operationally coupled to a port and a link. For example, 4 100G ports for each corresponding link that is a serial link running at 100G speed. As such, if any of the links and/or ports fails, the corresponding port will be taken out of packet distribution and the remaining operational ports will continue receiving packets. The remote link failure management engine can include hardware-based recovery management engine functionality described in U.S. application Ser. No. 18/744,190 “HARDWARE-BASED FAILURE RECOVERY ENGINE IN AN ARTIFICIAL INTELLIGENCE BACKEND NETWORK SYSTEM” incorporated herein in its entirety.

An ANC of an AI hardware may support 4 ports in 100G mode and 2 ports in 200G mode. The ATL enables adding a health bit (e.g., 4 bits for 4 ports) in ATL data and ACK packets to exchange local port health status between a Sender device and a Receiver device. In case of a link and/or port failure at a Receiver device (e.g., ANC), the Receiver device can communicate an indication to a Sender device (e.g., ANC) using a field associated with the health bit in the ACK. ACK will can be communicated back using an operational link and port of the Receiver device. Sender device upon receiving the ACK can read the bit via the field and update its Port Status Table (PST) for remote ports. The Sender device, based on updating the PST, can exclude the port because of the failed link, and perform operations based on the port being constructively deactivated via its status in the PST.

The hardware-based remote link failure management can operate independently of additional software or firmware resources, functioning autonomously once implemented. Unlike software-dependent systems that may require ongoing updates and intervention from administrators, hardware-based remote link failure management is designed to function without the need for continuous software management. This independence from software layers ensures efficient operation without consuming additional computing resources or requiring frequent adjustments.

Moreover, the inherent nature of hardware-based solutions allows for automated processes that execute tasks swiftly and efficiently. By integrating processing mechanisms directly into hardware components like specialized chips or modules, these solutions can perform operations at significantly faster speeds compared to software-based alternatives. This speed advantage stems from the optimized design of hardware circuits, which are tailored to execute specific functions without the overhead and abstraction typical of software execution on general-purpose CPUs.

In contrast to software-based schemes that rely on running programs and algorithms on flexible computing platforms, hardware-based remote link failure management leverages dedicated hardware resources to achieve superior performance and responsiveness. This specialization in hardware enables tasks to be executed with minimal latency, making them ideal for applications demanding real-time processing and high throughput. The hardware-based remote link failure management approach offers the dual advantages of autonomy from software dependencies and enhanced operational speed, making it a compelling choice for efficiency, reliability, and rapid processing in an AI backend network system.

### Example Systems and Resources

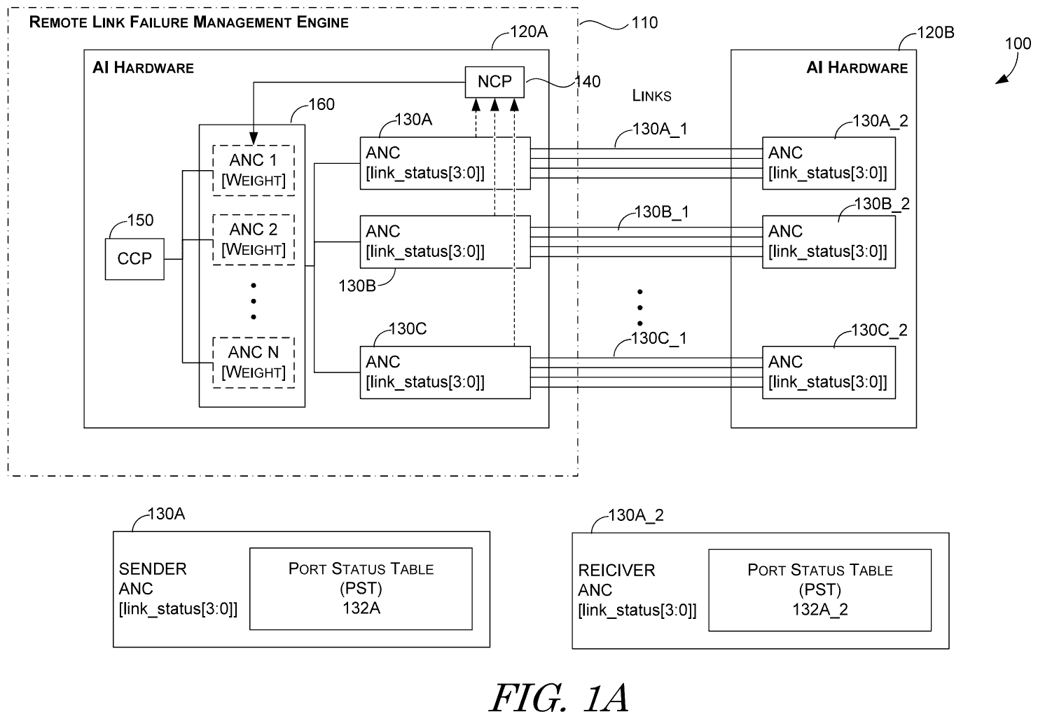

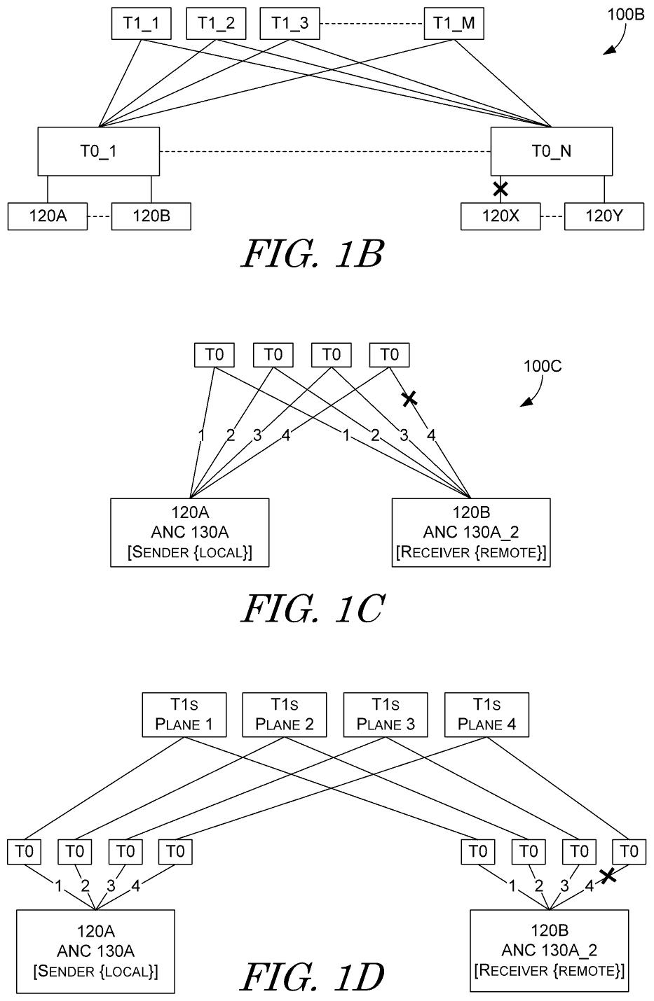

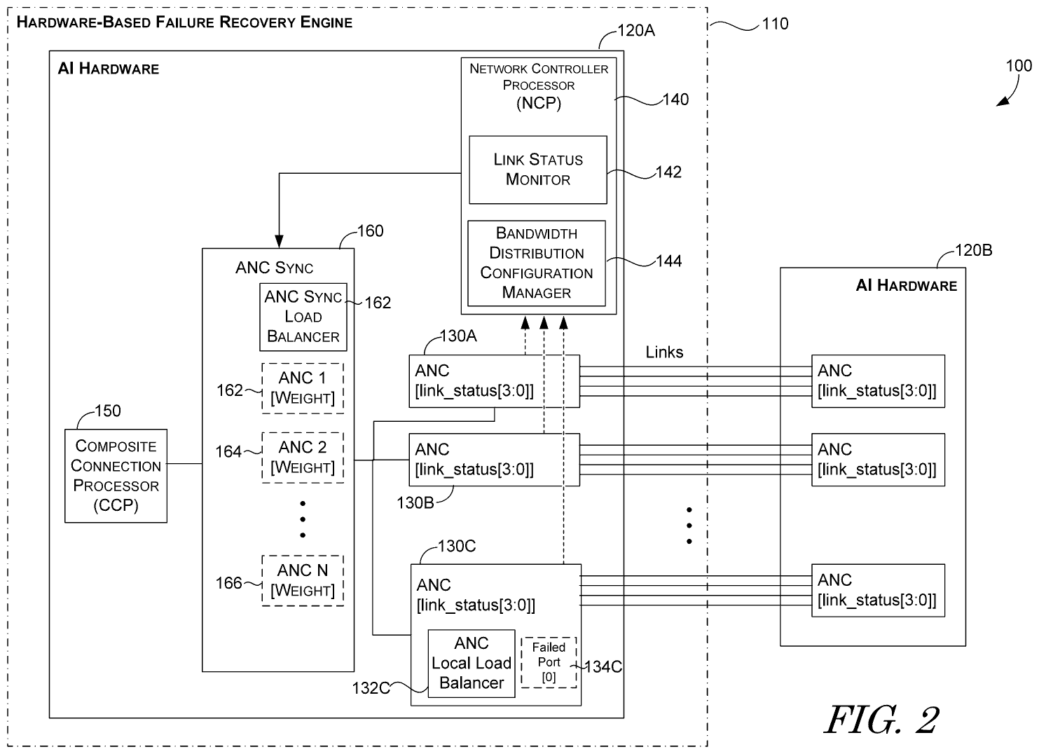

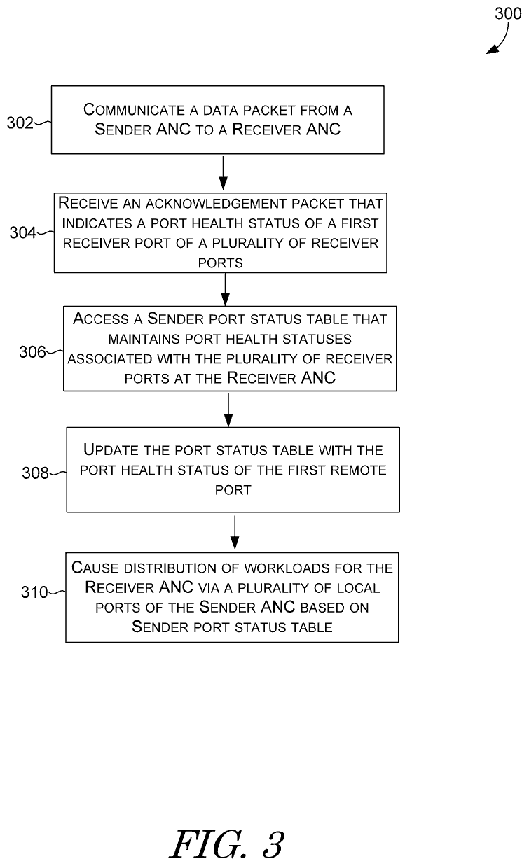

Aspects of the technical solution can be described by way of examples and with reference to FIGS. 1A-1D and 2. FIG. 1 illustrates a AI backend network system 100 with remote link failure management engine 110, AI hardware 120 (AI hardware 120A, AI hardware 120B), a plurality of ANCs (ANC 130A, ANC 130B, ANC 130C, ANC 130A_2, ANC 130B_2, 130C_2), link sets (e.g., sets of 4: link 130A_1, link 130B_1, and link 130C_1), Network Controller Processor (NCP) 140, Composite Connection Processor (CCP) 150, and ANC sync 160.

With reference to FIG. 1, FIG. 1 illustrates AI backend network system 100 that is an operating environment for AI hardware 120 (AI hardware 120A and AI hardware 120B). The AI hardware 120 can include an NCP 140 that manages communication operations of the AI hardware 120, ANCs that are multi-port controllers, ANC sync 160 that is a composite connection of multiple ANCs that operate together, and CCP 150 that manages the ANC sync. The plurality of ANCs can be associated with AI hardware 120A (i.e., ANC 130A, ANC 130B, and ANC 130C) and AI hardware 120B (i.e., ANC 130A_2, ANC 130B_2, 130C_2) communicating via links (e.g., link 130A_1, link 130B_1, and link 130C_1). An ANC (e.g., ANC 130A) can include a Port Status Table-PST 132A. PST is a structured record that contains health information about local ports and remote ports associated with the ANC. The remote link failure management engine 110 supports detecting, mitigating, and recovering from failures in the ports and links in AI hardware. In particular, the remote link failure management engine 110 supports disabling or deactivating a port of a plurality of ports in an ANC in AI hardware, and generating an updated bandwidth distribution configuration for distributing workloads across a plurality of ANCs including the ANC associated with the disabled port and the remaining operational ports.

With reference to FIG. 1B-1D, FIGS. 1B-1D illustrate corresponding AI backend network system 100B, AI backend network system 100C, and AI backend network system 100D having different configurations of AI hardware and PODs (e.g., Pod of Devices). For example, a first AI hardware and a second AI hardware in the same POD means the first AI hardware and the second AI hardware are physically located together, potentially sharing resources and communications paths. The first AI hardware and the second AI hardware in different PODs can imply separate physical locations, possibly requiring data transfer between them.

By way of illustration, AI backend network system 100B includes AI hardware (e.g., 120A, 120B, 120X and 120Y), top of rack switches (e.g., T0_1 and T0_N) and higher-level switches (e.g., T1_1, T1_2, T1_3, and T1_M). A POD can refer to a collection of interconnected AI or machine learning devices, such as GPUs, TPUs, or even edge devices like IoT sensors or smart cameras, working in concert to process data or execute AI algorithms. Each POD can represent a self-contained unit housing servers, storage, and networking equipment. As shown in AI backend network system 100B 120A and 120B can be in a first POD and 120X and 120Y can be a second POD. As discussed, AI hardware can include ANCs that support ports (e.g., 4 port in 100G port mode or 2 ports in 200G port mode). The hardware-based Transport Layer Protocol (i.e., AI Transport Layer Protocol “ATL”) is provided to handle remote link failures.

By way of illustration, in a 4 port configuration, 4 bits are added in the ATL data and ACK packs to exchange local port health status between a sender and a receiving. In case of a link and/or port failure at a Receive ANC, the Receive ANC can indicate the link and/or port failure to the Sender ANC using fields in the ACK. Operationally, an ACK is sent back using one of the remaining operation ports connected to the Receive ANC. Sender ANC, upon receiving the ACK, can use the health information in the ACK to update a Port Status Table (PST) for remote ports and exclude the particular port locally for data processing. For example, mechanisms associated with hardware-based failure recovery can be employed when communicating with deactivated remote port.

Turning to AI backend network system 100C, within this setup, a first AI hardware (i.e., 120A ANC 130A Sender {local})) and a second AI hardware (i.e., 120B ANC 130A_2 Receive {remote}) are positioned closely together, benefiting from direct proximity and efficient communication pathways. They communicate seamlessly via a dedicated switch known as a TOR (Top of Rack) switch, located within the same POD. The TOR switch acts as a local hub, facilitating high-speed data transfer between the AI hardware and other components within the POD. This proximity minimizes latency and optimizes performance, crucial for demanding AI tasks that require real-time processing capabilities.

Turning to AI backend network system 100C, a first AI hardware (e.g., 120A ANC 130A Sender {local}) resides in POD A, while the second AI hardware (e.g., 120B ANC 130A_2 Receive {remote}) is located in POD B within the same or different data center. Each POD maintains its own TOR switches, connecting servers and AI hardware internally. However, for the first AI hardware in POD A to communicate with the second AI hardware in POD B, data must traverse the data center network.

In this setup, data initially flows from the first AI hardware 120A through its local TOR switch in POD A. It then travels across the data center network, utilizing high-speed connections like fiber optics, to reach the corresponding TOR switch in POD B. Once arriving at POD B, the data is forwarded to the second AI hardware 120B. Beyond TOR switches, the data may encounter higher-level switches (e.g., T1s Plane 1, T1s Plane 2, T1s Plane 3, and T1s Plane 4) such as aggregation or spine switches, which manage traffic between PODs and ensure efficient routing.

Remote link failure management provide support for ANCs to maintain a Port Status Table (PST). Several different techniques can be used to maintain the PSTs. Maintaining a table of data in AI hardware, whether in hardware or firmware, involves storing and accessing structured data. AI hardware often includes embedded memory such as SRAM (Static Random-Access Memory) or specialized memory structures like content-addressable memory (CAM). These memories can store tables of data directly within the hardware itself. For firmware-based solutions, the table of data can be stored in non-volatile memory (e.g., flash memory or EEPROM) that is accessible by the firmware. The firmware manages the data, reads from it, and writes to it as needed. AI hardware can implement specific data structures optimized for its operations. For example, hash tables, lookup tables, or tree structures can be employed depending on the nature of the data and the required access patterns. ANCs can use ports which are operational and healthy (i.e., no link or port failure) on both side (i.e., local and remote) in the PST to load balance ATL packets. For example, a round robin method can be used to distribute packets or requests evenly across a ports. With round robin, each incoming packet is handed out to the next port in line, cycling through the port one by one. This ensures that all port share the workload equally over time, preventing any single port from becoming overloaded.

Remote link failure management functionality can be described with respect to PST tables below. At start, both the Source ANC and the Receiver ANC may have all four links and ports operational. As shown in Table 1, Table 1 includes ANCs, Sender-Local, Sender-Remote, Receiver-Local, and Receiver-Remote and corresponding port status indicating 1 for up, and 0 for down.

TABLE 1

| | Port 0 | Port 1 | Port 2 | Port 3 |
|---|---|---|---|---|
| | status | status | status | status |
| | (1: up, 0: | (1: up, 0: | (1: up, 0: | (1: up, 0: |
| ANCs | down) | down) | down) | down) |
| Sender-Local | 1 | 1 | 1 | 1 |
| Sender-Remote | 1 | 1 | 1 | 1 |
| Receiver-Local | 1 | 1 | 1 | 1 |
| Receiver-Remote | 1 | 1 | 1 | 1 |

Sender ANC communicates packets using all four ports and Receive ANC communicates ACKs using all four ports (e.g., using a round robin method). Both data packets and corresponding ACK packets can carry their local ANC port health status. The port health status can be carried in one hot-encoded format (e.g., a bit per port). A hot-encoded format can for a packet can refer to a method of structuring data within a network packet where specific bits or fields represent binary states or flags indicating the presence or absence of certain features, options, or characteristics. This encoding scheme efficiently communicates multiple attributes or configurations using binary values, typically with each bit or group of bits representing a distinct parameter or setting within the packet's header or payload. Hot-encoded packets allow for compact and streamlined transmission of diverse information, facilitating rapid interpretation and processing by network devices and protocols. As shown in Table 2, ATL packet type can be a data packet or an ACK packet that includes port health status information provided a hot-encoded format (e.g., a bit per port).

TABLE 2

| ATL.Packet_type | ATL.Port_health | Description |
|---|---|---|
| Data | 4′b1111 | All four ports Up |
| ACK | 4′b1111 | All four ports Up |

If a link and/or port failure associated with port 3 is determined, Receiver ANC can update its local PST table to indicate port 3 has been deactivated. As shown in FIG. 3, Receiver-Local and Port 3 status corresponds to 0 indicating the port has been disabled or deactivated due to a link and/or port failure.

TABLE 3

| | Port 0 | Port 1 | Port 2 | Port 3 |
|---|---|---|---|---|
| | status | status | status | status |
| | (1: up, 0: | (1: up, 0: | (1: up, 0: | (1: up, 0: |
| ANCs | down) | down) | down) | down) |
| Sender-Local | 1 | 1 | 1 | 1 |
| Sender-Remote | 1 | 1 | 1 | 1 |
| Receiver-Local | 1 | 1 | 1 | 0 |
| Receiver-Remote | 1 | 1 | 1 | 1 |

Receiver ANC then begins communicating ACK packets using ports 0, 1, and 2. Receiver ANC communicates its local ANC port health status in a hot-encoded format.

TABLE 4

| ATL.Packet_type | ATL.Port_health | Description |
|---|---|---|
| ACK | 4′b1110 | Port 3 down |

Sender ANC updates its local port PST per the update from the Receiver ANC. In particular, the Sender ANC updates its local port PST using the port health status received from ACK packet. As shown, Sender-Remote and Receive-Local port 3 status indicates that port 3 has been disabled or deactivated.

TABLE 5

| | Port 0 | Port 1 | Port 2 | Port 3 |
|---|---|---|---|---|
| | status | status | status | status |
| | (1: up, 0: | (1: up, 0: | (1: up, 0: | (1: up, 0: |
| ANCs | down) | down) | down) | down) |
| Sender-Local | 1 | 1 | 1 | 1 |
| Sender-Remote | 1 | 1 | 1 | 0 |
| Receiver-Local | 1 | 1 | 1 | 0 |
| Receiver-Remote | 1 | 1 | 1 | 1 |

Both data packets and corresponding ACKs packet will continue to carry their local ANC port health status on one hot encoded (one bit per port). As shown, data ATL packet indicates all port are up for the Sender ANC; however, the ACK ATL packet indicates port 3 is down.

TABLE 6

| ATL.Packet_type | ATL.Port_health | Description |
|---|---|---|
| Data | 4′b1111 | All Ports Up |
| ACK | 4′b1110 | Port 3 down |

Sender ANC and Receive ANC utilizes remaining operational healthy ports on both local and remote sides to load balance packets including dynamically distributes incoming and outgoing traffic across multiple operational ports.

With reference to FIG. 1A, FIG. 1A illustrates an example Sender ANC (e.g., ANC 130A) with a Sender Port Status Table (e.g., PST 132A) and Receiver ANC (e.g., ANC 130A_2) with a Receiver Port Status Table (e.g., PST 132A_2). Sender ANC can be associated with a plurality of sender ports and Receiver ANC can be associated with a plurality of receiver ports. The remote link failure management engine 110 support providing remote link failure management functionality associated with the Sender ANC and Remote ANC.

Operationally, the Sender ANC communicates a data packet to the Receiver ANC. The Sender ANC and the Receiver ANC are operationally coupled within a single Pod of Devices (POD) or operationally coupled outside a single Pod of Devices (POD). The Sender ANC and the Receiver ANC operate based on Artificial Intelligence (AI) Transport Layer Protocol (“ATL”) enables adding a health bit in ATL data and ATL ACK packets. The data packet and the acknowledgment packet operate based on a hot-encoded format associated with providing port health status.

Based on communicating the data packet, the Sender ANC receives an acknowledgement packet that indicates a port health status of a first receiver port of a plurality of receiver ports at the Receiver ANC. The port health status indicates that the first receiver port has been deactivated at the Receiver ANC. Based on the port health status indicating that the first receiver port has been deactivated at the Receiver ANC, the Sender ANC accesses a Sender Port Status Table that maintains port health statuses associated with the plurality of receiver ports at the Receiver ANC. The Sender Port Status Table further maintains port health statuses associated with the plurality of sender ports at the Sender ANC.

The Sender ANC updates the Sender Port Status Table with the port health status of the first remote port, such that the port health status of the first remote port in the Sender Port Status Table indicates that first remote port has been deactivated. The Sender ANC causes distribution of workloads for the Receiver ANC via a plurality of sender ports of the Sender ANC based on the Sender Port Status Table. The Sender ANC and the Receiver ANC utilize their corresponding Port Status Table to identify operational port for communicating workloads.

From the Receiver ANC perspective, Receiver ANC accesses a link status that indicates a link failure condition associated with a first receiver port of a plurality of receiver ports at the Receiver ANC. A link operationally coupled to a link failure detection circuit associated with a register bit for detecting link failure conditions. The link failure condition can be based on a failed link or a failed port, are a combination of both.

Based on the link status, the Receiver ANC access a Receiver ANC Port Status Table that maintains port health status associated with the plurality of receiver ports at the Receiver ANC. The Receiver ANC updates the Receiver ANC Port Status Table with a port health status of the first receiver port, where the port health status of the first remote port indicates that the first receiver port has been deactivated.

The Receiver ANC receives a data packet from a Sender ANC. Based on the port health status of the first receiver port and the data packet, the Receiver ANC communicates, to the Sender ANC, an acknowledgement packet that indicates the port health status of the first receiver port at the Receiver ANC. The acknowledgement packet uses a hot-encoded format to communicate the port health status of the first remote port. The acknowledgement packet is communicated to cause the Sender ANC to update a Sender ANC Port Status Table. The Receiver ANC uses a local load balancer to distribute acknowledgment packets to the operational ports in the plurality of receiver ports.

With reference to FIG. 2, FIG. 2 illustrates the AI backend network system 100 with additional components that facilitate providing hardware-based failure recovery functionality. The remote link failure management engine 110 ensures continuous and reliable operation by detecting, diagnosing, and mitigating network failures efficiently. The remote link failure management engine 110 uses the NCP 140 to manage remote link failure management engine resources. In operation, the NCP 140 receives a link status indicating a link failure condition associated with a port (e.g., port 134C) of ANC 130C. It is contemplated that the link failure generated because of a failed port. The ANC 130C is a multi-port controller associated with a plurality ports (e.g., port 0, 1, 2, and 3). The ANC 130 supports two or more multi-port modes (e.g., 2 ports at 200G or 4 ports at 100G). The ANC 130C is associated with a composite connection (e.g., ANC sync 160) of a plurality of ANCs (e.g., ANC 1 162 and ANC 2 164 . . . ANC N 166).

While the illustrations depict the ANCs linked to the ANC sync via a shared connection, it contemplated that different types of configurations are feasible. For instance, each ANC might feature its own dedicated connection to the ANC sync. Alternatively, at least one ANC could possess an independent connection to the ANC sync, with the other ANCs having a shared connection. The plurality of ANCs are associated with a bandwidth distribution configuration that allocates the plurality of ANCs corresponding ANC bandwidth weights for processing workloads. The link status is based on an interrupt triggered by the ANC, the link status is associated with a link failure detection circuit and a register bit of a corresponding link of the port. The NCP 140 (e.g., link status monitor 142) uses a lightweight code to confirm link failure condition is not based on a transient glitch.

Based on the link status indicating the link failure condition, the NCP 140 deactivates the port 134C. The NCP 140 (e.g., bandwidth distribution configuration manager 144) generates an updated bandwidth distribution configuration associated with the ANC sync 160. In some embodiments, generating the updated bandwidth distribution comprises scaling back an ANC bandwidth weight of the ANC proportionally to a number of deactivated ports to prevent any flow control issues or build-up between an ANC sync of the composite connection and the plurality of ANCs. Other adjustment variations are contemplated (e.g., fixed-step adjustment, threshold-based adjustment, priority-based adjustment, algorithmic adjustment). The updated bandwidth distribution configuration is based on the ANC 130C comprising the port 134C. The NCP 140 causes distribution of workloads via the composite connection of the plurality ANCs based on the updated bandwidth distribution configuration. The NCP 140 communicates the updated bandwidth distribution configuration to cause reconfiguration the ANC bandwidth weights of the plurality of ANC. It is contemplated the ANC 130C can receive the ANC bandwidth weight from the NCP and signal an ANC bandwidth weight adjustment using hardware-based side band signaling between the ANC and the composite connection.

The NCP 140 causes distribution of workloads via the composite connection of the plurality ANCs based on the updated bandwidth distribution configuration. Causing distribution of workloads via the composite connection of the plurality ANCs is based on the updated bandwidth distribution configuration is based on CCP 150 using the ANC bandwidth weights in load balancing logic (e.g., ANC sync load balancer 162) for assigning workloads to the plurality of ANCs. The ANC 130C receives a workload via the CCP 150 and the ANC sync 160. Receiving the workload is based on the CCP using the ANC bandwidth weight of the ANC. The ANC 130C uses a local load balancer (e.g., ANC local load balancer 132C) to distribute the workload to the operational ports in the plurality of ports.

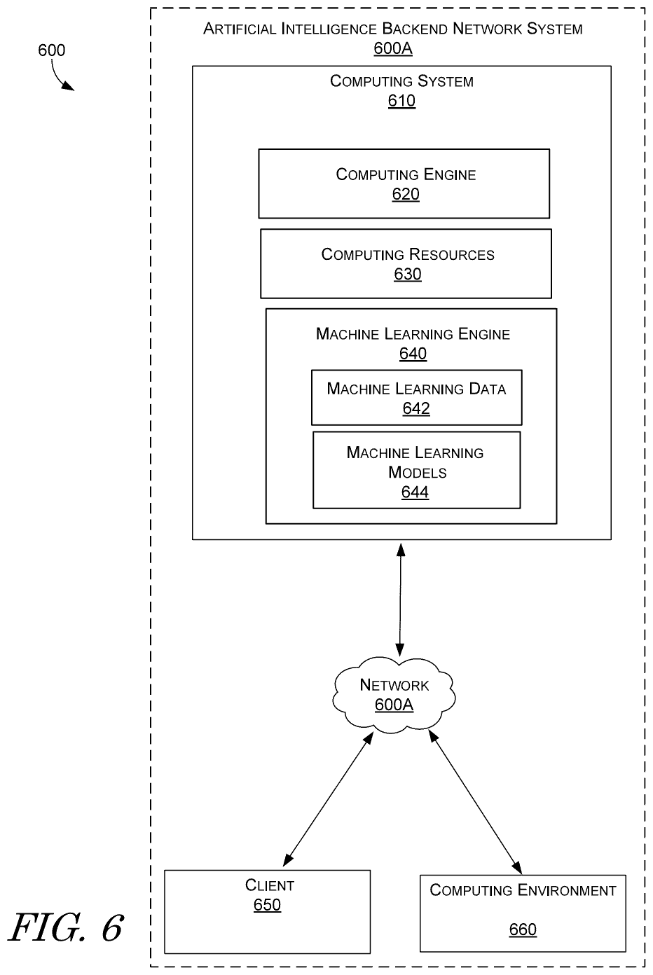

Aspects of the technical solution have been described by way of examples and with reference to FIGS. 1 and 2. FIG. 1 is a block diagram of an exemplary technical solution environment, based on example environments described with reference to FIGS. 6, 7 and 8 for use in implementing embodiments of the technical solution are shown. Generally the technical solution environment includes a technical solution system suitable for providing the example AI backend network system 100 in which methods of the present disclosure may be employed. In particular, FIG. 1 illustrates a high level architecture of the AI backend network system 100 in accordance with implementations of the present disclosure, among other engines, managers, generators, selectors, or components not shown (collectively referred to herein as “components”).

### Example Methods

With reference to FIGS. 3, 4, and 5, flow diagrams are provided illustrating methods for providing remote link failure management using a remote link failure management engine of an artificial intelligence (AI) backend network system. The methods may be performed using the AI backend network system described herein. In embodiments, one or more computer-storage media having computer-executable or computer-useable instructions embodied thereon that, when executed, by one or more processors can cause the one or more processors to perform the methods (e.g., computer-implemented method) in the AI backend network system (e.g., a computerized system).

Turning to FIG. 3, a flow diagram is provided that illustrates a method 300 for providing remote link failure management using a remote link failure management engine of an AI backend network system. At block 302, communicate a data packet from a Sender ANC to a receiver ANC. At block 304, receiver an acknowledgement packet that indicates a port health status of a first receiver port of a plurality of receiver ports. At block 306, access a Sender Port Status Table that maintains port health statuses associated with the plurality of receiver ports at the Receiver ANC. At block 308, update the Sender Port Status Table with the port health status of the first remote port. At block 310, cause distribution of workloads for the Receiver ANC via a plurality of local ports of the Sender ANC based on the Sender Port Status Table.

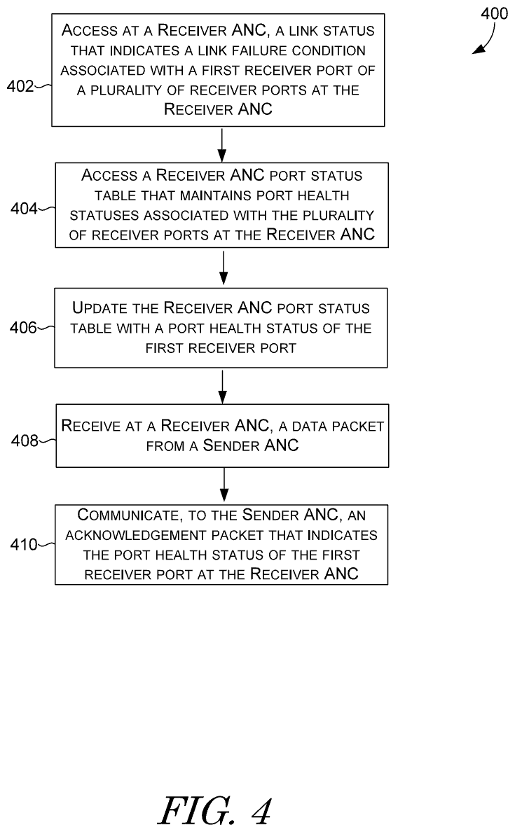

Turning to FIG. 4, a flow diagram is provided that illustrates a method 400 for providing remote link failure management using a remote link failure management engine of an AI backend network system. At block 402, access, at a Receiver ANC, a link status that indicates a link failure condition associated with a first receiver port of a plurality of receiver ports at the Receiver ANC. At block 404, access a Receive ANC Port Status Table that maintains port health statuses associated with the plurality of receiver ports at the Receiver ANC. At block 406, update the Receiver ANC Port Status Table with a port health status of the first receiver port. At block 408, receive at a Receiver ANC, a data packet from a Sender ANC. At block 410, communicate, to the Sender ANC, an acknowledgement packet that indicates the port health status of the first receiver port at the Receiver ANC.

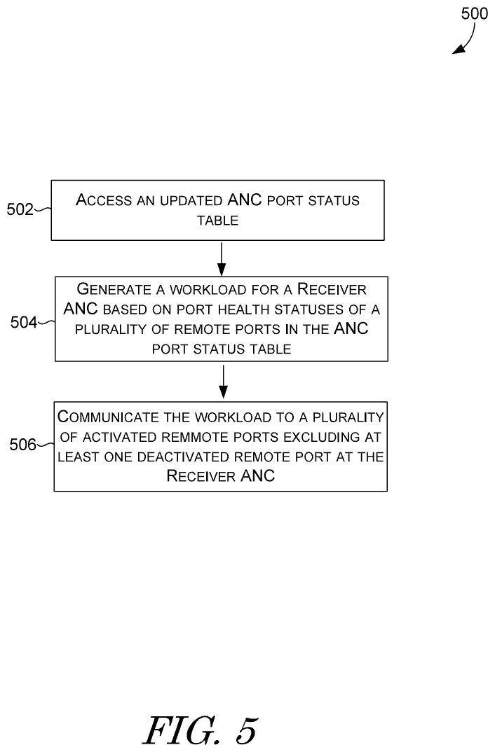

Turning to FIG. 5, a flow diagram is provided that illustrates a method 500 for providing remote link failure management using a remote link failure management engine of an AI backend network system. At block 502, access an updated ANC Port Status Table. At block 504, generate a workload for a Receiver ANC based on port health statuses of a plurality of remote ports in the ANC Port Status Table. At block 506, communicate the workload to a plurality of activated ports excluding at least one deactivated remote port at the Receiver ANC.

### Technical Improvement

Embodiments of the present techniques have been described with reference to several inventive features (e.g., operations, systems, engines, and components) associated with an artificial intelligence (AI) backend network system. Inventive features described include: operations, interfaces, data structures, and arrangements of computing resources associated with providing the functionality described herein relative with reference to a remote link failure management engine. Functionality of the embodiments of the present invention have further been described, by way of an implementation and anecdotal examples—to demonstrate that the operations for providing the remote link failure management engine as a solution to a specific problem in remote link failure management technology to improve computing operations in AI backend network systems.

Advantageously, remote link failure management engine in AI hardware provides several detailed advantages associated with real-time detection, high reliability, scalability, and integrated features. The remote link failure management engine enables monitoring to detect link or port failures instantly, ensuring prompt response and minimizing downtime in AI applications where data throughput and latency are critical. The remote link failure management engine is engineered for high reliability, with robust mechanisms for accurate fault detection and minimal false positives. This reliability enables maintaining continuous operation of AI systems that rely on uninterrupted data flow. AI environments often involve distributed systems with numerous interconnected devices. The remote link failure management engine can scale efficiently to monitor and manage network links and ports across these complex infrastructures, ensuring consistent performance as the network expands. The remote link failure management engine includes built-in features that enhance network resilience and simplify fault recovery processes. In this way, the remote link failure management engine provides enhanced performance for network operations and specifically the demands of AI-driven applications.

### Additional Support for Detailed Description

### Example Computing System in a Computing Environment

Referring now to FIG. 6, FIG. 6 illustrates a computing environment in which implementations of the present disclosure may be employed. In particular, FIG. 6 shows a high level architecture of an example cloud computing platform 600, artificial intelligence (AI) backend network system 600A, and computing system 610 that can host a technical solution environment. It should be understood that this and other arrangements described herein are set forth only as examples. For example, as described above, many of the elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown.

The cloud computing platform 600 provides computing system resources for different types of managed computing environments. For example, the cloud computing platform supports delivery of computing services—including compute, servers, storage, databases, networking, and intelligence. The components of cloud computing environment 600 may communicate with each other over a network 600A which may include, without limitation, one or more local area networks (LANs) and/or wide area networks (WANs).

The AI backend network system 600A provides a specialized infrastructure designed to support the computational demands of artificial intelligence (AI) workloads, including both training and inference tasks. The AI backend network systems 600A consists of interconnected components that facilitate the efficient processing, communication, and management of data into, out of, or between a distributed computing environment. Operations include data processing, handling input data, intermediate results, and output data, alongside complex computations for AI tasks, communication facilitating seamless interaction among components, and resource management overseeing optimal utilization of compute nodes, accelerators (e.g., GPUs, TPUs), memory, and storage. Interfaces encompass network interfaces enabling high-speed communication between nodes, APIs providing standardized interaction methods for developers, and management interfaces for system monitoring and administration. Data support functionalities include storage, data movement, transformation, and replication with backup mechanisms, ensuring data durability and reliability. In this way, the AI backend network system serves as the backbone infrastructure for AI workloads, facilitating efficient and scalable AI processing across distributed computing environments through its comprehensive operations, interfaces, and data management functionalities.

The cloud computing platform 600 provides the foundational infrastructure and resources for deploying and managing computing workloads, including AI. AI backend network system 600A includes specialized infrastructures tailored for supporting the unique computational demands of AI workloads. The relationship between the two involves resource provisioning, integration, orchestration, and data processing, enabling organizations to leverage cloud-based resources effectively for AI development and deployment.

The computing system 610 provides computing functionality for computing environments. For example, the computing system 610 is a platform or framework that leverages advanced technologies such as artificial intelligence (AI), machine learning (ML), data mining, and big data analytics to extract actionable insights and knowledge from large and complex datasets. In this way, the computing system 610 provides a computing environment that enables organizations to make informed decisions and optimize operations.

The computing system 610 includes a computing engine 620 that is a computing environment that supports executing computational tasks associated with the computing system 610. The computing engine 620 can be a hardware or software component that performs computational operations, such as, mathematical calculations, data processing, and algorithm execution. The computing system 610 integrates computing resources 630 into computing system 610 to effectively provide computing functionality in a computing environment.

The computing resources 630 refer to computing elements (e.g., components, capability, or entities) that collectively enable the computing engine 620 operations. The computing resources 630 encompass a spectrum of computing elements, beginning with the diverse operations the computing resources 630 can perform, ranging from complex computations to data manipulations. Interfaces, an integral part of the computing resources 630, provide the means for both user interaction and seamless integration with external systems, ensuring a dynamic and interactive computing experience. The data facet of the data computing resources 630 involves various types: input data, which is the information provided for processing; processing data, representing the data manipulated during computational tasks; and output data, the results generated by the computing engine 620. In this way, the computing resources 630 support the broader computing engine 620 and computing system 610.

Machine learning engine 640 is a machine learning framework or library that operates as a tool for providing infrastructure, algorithms, capabilities for designing, training, and deploying machine learning models. The machine learning engine 640 can include pre-built functions and APIs that enable building and applying machine learning techniques. The machine learning engine 640 can provide a machine learning workflow from data processing and feature extraction to model training, evaluation, and deployment.

Machine learning data 642 refers to the structured or unstructured information used to train, validate, and test machine learning models. This machine learning data 642 typically comprises input features (also known as independent variables or predictors) and their corresponding target values (also known as dependent variables or labels). Machine learning data 642 can come from various sources, such as databases, sensor readings, text documents, images, audio recordings, or streaming data sources. Machine learning data 642 may require preprocessing, cleaning, and transformation to ensure its suitability for training machine learning models. Additionally, machine learning data 642 is often divided into training, validation, and testing sets to assess the performance and generalization ability of trained models accurately.

Machine learning models 644 are algorithms or mathematical representations that learn patterns and relationships from the provided data to make predictions or decisions without being explicitly programmed. Machine learning models 644 models are trained using the machine learning data 642, where they iteratively adjust their internal parameters or coefficients to minimize prediction errors or maximize performance metrics. Machine learning models 644 can be classified into various types based on their learning algorithms and the nature of the problem they address, including supervised learning models (e.g., regression, classification), unsupervised learning models (e.g., clustering, dimensionality reduction), and reinforcement learning models. Once trained, machine learning models 644 can be deployed in production environments to make predictions on new, unseen data instances. Regular evaluation and monitoring of model performance are essential to ensure their accuracy, reliability, and effectiveness in real-world applications.

The computing client 650 supports access to computing system 610. The computing client 650 can be provided as a user client or an administrator client to support user and administrator functionality associated with the computing environment 660, computing engine 620, or computing system 610. The computing client 650 can also support accessing computing visualizations and causing display of the computing visualization. The computing client 650 can include a computing engine client that supports receiving computing information associated computing engine 620 output from the computing system 610 and causing presentation of the computing information. The computing information can specifically include computing visualizations associated with the computing engine 620 output.

Computing environment 660 is a computing environment that is integrated into the computing system 610. The computing environment 660 is characterized by an infrastructure, where data from various sources within the ecosystem, including servers, networks, applications, sensors, and user interactions, can be aggregated and processed by the computing system 610 to perform computing tasks. The computing environment 660 can be associated with middleware and integration layers facilitate seamless data flow, while computing infrastructure, encompassing cloud-based resources, distributed computing frameworks, and optimized storage systems, supports functionality associated with the computing.

The AI backend network system can provide a hardware-based recovery engine via remote link failure management engine (e.g., remote link failure management engine 110 in FIG. 1A), the hardware-based recovery management engine can be associated with a plurality of ANCs. Each ANC can be operationally coupled to a port and a link. For example, 4 100G ports for each corresponding link that is a serial link running at 100G speed. An ANC can be configured as a part of a composite connection or ANC sync that includes a plurality of ANCs. The composite connection can be multiple ANCs managed via a single logical interface. This technique is employed to enhance networking performance, provide redundancy, and ensure fault tolerance. The composite connection allows multiple ANCs to work together, creating a more resilient and higher-capacity network connection. The sync or synchronization of the ANC sync may refer to the synchronization process that ensures multiple ANCs work together seamlessly as a single logical connection. The synchronization enables maintaining data consistency, proper load balancing, and effective failover mechanisms across the aggregated links.

The ANC sync and/or composite connection are managed via a Composite Connection Processor (CCP). The CCP operates as a specialized component or subsystem in the AI hardware that manages and optimizes composite connections. Composite connections involve the aggregation of ANCs to function as a single, logical connection, providing increased bandwidth, redundancy, and load balancing. The CCP operates based on a bandwidth distribution configuration that is an allocation and/or limits of bandwidth for each ANC and/or port. For example, each ANC is assigned an ANC bandwidth weight. The CCP distributes packets to the plurality of ANCs based on corresponding ANC bandwidth weights in the bandwidth distribution configuration. The bandwidth distribution configuration can include a weight attribute that assigns an ANC bandwidth weight to each of the ANCs, such that, the workloads are processed at the ANC based on the corresponding assigned ANC bandwidth weight.

The ANC and CCP can operate based on corresponding load balancers. A load balancer distributes incoming network traffic across resources (i.e., ports or ANCs) to ensure no single resource becomes overwhelmed. This helps optimize resource use, improve response times, and enhance the reliability and availability of a networking functionality. Each ANC can include a local load balancer with a load balancing logic. The local load balancer supports even distribution of packets across the ports (e.g., 4 ports or 3 operational ports and bypassing one deactivated port) of the ANC. The local load balancer automatically stops communicating packets on a deactivated port and link (e.g., if port 0 of ports 0, 1, 2, 3, and 4 is down, the ANC communicates packets only to ports 1, 2 and 3). The CCP implements an ANC sync load balancer with a load balancing (or sharding) logic—based on bandwidth distribution configuration—as discussed in more detail below.

The NCP operates as a centralized component to manage the hardware-based failure recovery management for the AI hardware. The NCP can employ network interface firmware to provide hardware-based failure recovery management functionality. The firmware provides low-level control and operational functionality providing hardware-based failure recovery. The NCP receives the statuses of links (i.e., link status) from the ANC. The ANC can communicate link failure condition in a link using an interrupt (e.g., a signal from the ANC to the NCP) to the NCP. In some embodiments, NCP can implement a lightweight code that supports confirming the link failure condition compared to a transient glitch. Transient glitches are brief, temporary disruptions in caused by various factors such as electromagnetic interference, power supply variations, and physical disturbances. Confirming a transient glitch involves a systematic approach that includes real-time monitoring, data analysis, and the use of diagnostic tools. For example, tracking performance metrics like latency, packet loss, and error rates; or comparing current performance data with historical trends. As such, a determination is made that the link failure is not associated with a transient glitch prior to proceed with hardware-based failure recovery operations.

Upon confirming the link failure, the NCP disables (i.e., deactivates) a port associated with the link failure at an ANC. The NCP then generates an updated bandwidth distribution configuration associated with the plurality of ANCs in the ANC sync for composite connections. The updated bandwidth distribution configuration is based on reconfigured weights (i.e., ANC bandwidth weights) for the ANCs. As previously mentioned, the CCP load balances based on the bandwidth distribution configuration. In particular, the NCP by changing the weights of the ANCs and communicating the updated bandwidth distribution configuration, load balancing (or sharding) logic in the ANC sync—via the CCP—ensures fair distribution of bandwidth among the plurality of ANCs. For example, scaling back an ANC bandwidth weight adjustment can be in proportional manner to avoid any flow control/build up between the ANC sync and any of the ANCs (e.g., an ANC with a port associated with a link failure).

By way of illustration, every ANC may initially have a weight of 4—one for each port—and upon failure of a port in an ANC, an ANC sync load balancer will use ¾ of the workload to the ANC with weight 3 compare to ANCs with weight 4. The updated bandwidth distribution configuration indicates ANC bandwidth weight adjustments. ANC bandwidth adjustments can be signaled to the ANC sync via hardware-based side band signaling between the ANC and the ANC sync. Side band signaling can be performed in scenario where NCP resources are limited. The side band signaling refers to using a separate, auxiliary, or distinct communication channel between the ANC and the ANC sync. In this way, a composite connection configured via the CCP can continue to operate reliably in case of a single or multiple link failure at a single or multiple ANCs in the AI hardware-without requiring manual intervention or interruption of workloads.

### Example Distributed Computing System Environment

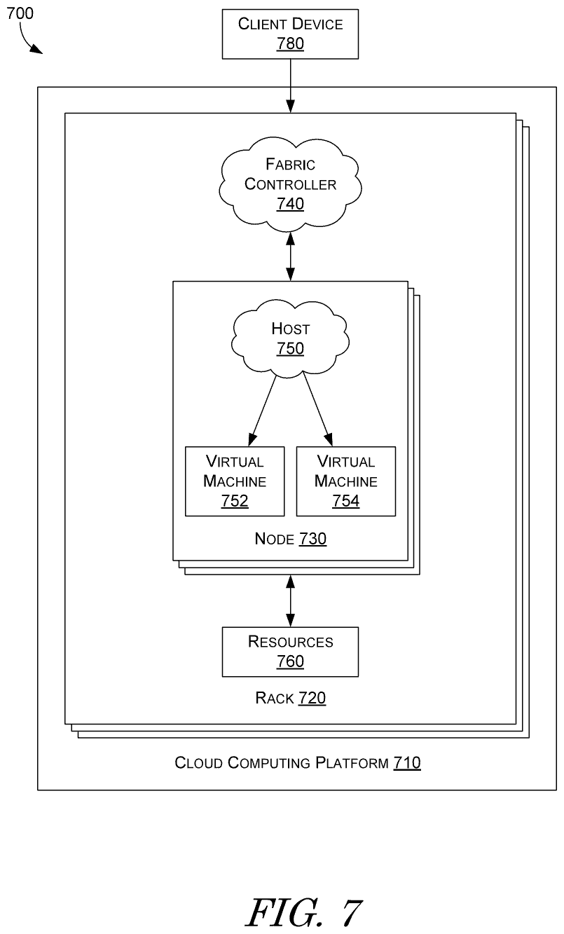

Referring now to FIG. 7, FIG. 7 illustrates an example distributed computing environment 700 in which implementations of the present disclosure may be employed. In particular, FIG. 7 shows a high level architecture of an example cloud computing platform 710 that can host a technical solution environment, or a portion thereof (e.g., a data trustee environment). It should be understood that this and other arrangements described herein are set forth only as examples. For example, as described above, many of the elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown.

Data centers can support distributed computing environment 700 that includes cloud computing platform 710, rack 720, and node 730 (e.g., computing devices, processing units, or blades) in rack 720. The technical solution environment can be implemented with cloud computing platform 710 that runs cloud services across different data centers and geographic regions. Cloud computing platform 710 can implement fabric controller 740 component for provisioning and managing resource allocation, deployment, upgrade, and management of cloud services. Typically, cloud computing platform 710 acts to store data or run service applications in a distributed manner. Cloud computing infrastructure 710 in a data center can be configured to host and support operation of endpoints of a particular service application. Cloud computing infrastructure 710 may be a public cloud, a private cloud, or a dedicated cloud.

Node 730 can be provisioned with host 750 (e.g., operating system or runtime environment) running a defined software stack on node 730. Node 730 can also be configured to perform specialized functionality (e.g., compute nodes or storage nodes) within cloud computing platform 710. Node 730 is allocated to run one or more portions of a service application of a tenant. A tenant can refer to a customer utilizing resources of cloud computing platform 710. Service application components of cloud computing platform 710 that support a particular tenant can be referred to as a multi-tenant infrastructure or tenancy. The terms service application, application, or service are used interchangeably herein and broadly refer to any software, or portions of software, that run on top of, or access storage and compute device locations within, a datacenter.

When more than one separate service application is being supported by nodes 730, nodes 730 may be partitioned into virtual machines (e.g., virtual machine 752 and virtual machine 754). Physical machines can also concurrently run separate service applications. The virtual machines or physical machines can be configured as individualized computing environments that are supported by resources 760 (e.g., hardware resources and software resources) in cloud computing platform 710. It is contemplated that resources can be configured for specific service applications. Further, each service application may be divided into functional portions such that each functional portion is able to run on a separate virtual machine. In cloud computing platform 710, multiple servers may be used to run service applications and perform data storage operations in a cluster. In particular, the servers may perform data operations independently but exposed as a single device referred to as a cluster. Each server in the cluster can be implemented as a node.

Client device 780 may be linked to a service application in cloud computing platform 710. Client device 780 may be any type of computing device, which may correspond to computing device 780 described with reference to FIG. 7, for example, client device 780 can be configured to issue commands to cloud computing platform 710. In embodiments, client device 780 may communicate with service applications through a virtual Internet Protocol (IP) and load balancer or other means that direct communication requests to designated endpoints in cloud computing platform 710. The components of cloud computing platform 710 may communicate with each other over a network (not shown), which may include, without limitation, one or more local area networks (LANs) and/or wide area networks (WANs).

### Example Computing Environment

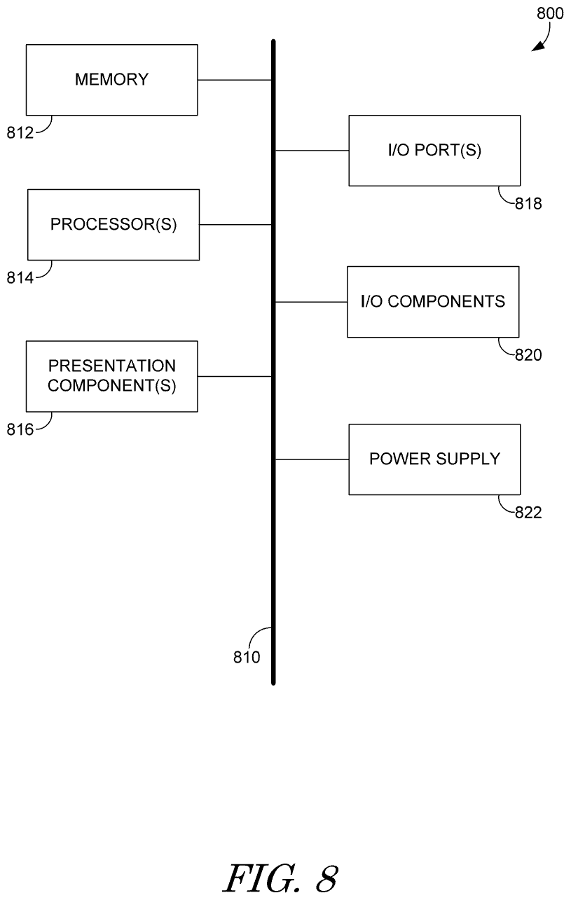

Having briefly described an overview of embodiments of the present technical solution, an example operating environment in which embodiments of the present technical solution may be implemented is described below in order to provide a general context for various aspects of the present technical solution. Referring initially to FIG. 8 in particular, an example operating environment for implementing embodiments of the present technical solution is shown and designated generally as computing device 800. Computing device 800 is but one example of a suitable computing environment and is not intended to suggest any limitation as to the scope of use or functionality of the technical solution. Neither should computing device 800 be interpreted as having any dependency or requirement relating to any one or combination of components illustrated.

The technical solution may be described in the general context of computer code or machine-useable instructions, including computer-executable instructions such as program modules, being executed by a computer or other machine, such as a personal data assistant or other handheld device. Generally, program modules including routines, programs, objects, components, data structures, etc. refer to code that perform particular tasks or implement particular abstract data types. The technical solution may be practiced in a variety of system configurations, including hand-held devices, consumer electronics, general-purpose computers, more specialty computing devices, etc. The technical solution may also be practiced in distributed computing environments where tasks are performed by remote-processing devices that are linked through a communications network.

With reference to FIG. 8, computing device 800 includes bus 810 that directly or indirectly couples the following devices: memory 812, one or more processors 814, one or more presentation components 816, input/output ports 818, input/output components 820, and illustrative power supply 822. Bus 810 represents what may be one or more buses (such as an address bus, data bus, or combination thereof). The various blocks of FIG. 8 are shown with lines for the sake of conceptual clarity, and other arrangements of the described components and/or component functionality are also contemplated. For example, one may consider a presentation component such as a display device to be an I/O component. Also, processors have memory. We recognize that such is the nature of the art, and reiterate that the diagram of FIG. 8 is merely illustrative of an example computing device that can be used in connection with one or more embodiments of the present technical solution. Distinction is not made between such categories as “workstation,” “server,” “laptop,” “hand-held device,” etc., as all are contemplated within the scope of FIG. 8 and reference to “computing device.”

Computing device 800 typically includes a variety of computer-readable media. Computer-readable media can be any available media that can be accessed by computing device 800 and includes both volatile and nonvolatile media, removable and non-removable media. By way of example, and not limitation, computer-readable media may comprise computer storage media and communication media.

Computer storage media include volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 800. Computer storage media excludes signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 812 includes computer storage media in the form of volatile and/or nonvolatile memory. The memory may be removable, non-removable, or a combination thereof. Exemplary hardware devices include solid-state memory, hard drives, optical-disc drives, etc. Computing device 800 includes one or more processors that read data from various entities such as memory 812 or I/O components 820. Presentation component(s) 816 present data indications to a user or other device. Exemplary presentation components include a display device, speaker, printing component, vibrating component, etc.

I/O ports 818 allow computing device 800 to be logically coupled to other devices including I/O components 820, some of which may be built in. Illustrative components include a microphone, joystick, game pad, satellite dish, scanner, printer, wireless device, etc.

### Additional Structural and Functional Features

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions) can be used in addition to or instead of those shown.

Embodiments described in the paragraphs below may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the technical solution is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present technical solution are described with reference to a distributed computing environment; however the distributed computing environment depicted herein is merely exemplary. Components can be configured for performing novel aspects of embodiments, where the term “configured for” can refer to “programmed to” perform particular tasks or implement particular abstract data types using code. Further, while embodiments of the present technical solution may generally refer to the technical solution environment and the schematics described herein, it is understood that the techniques described may be extended to other implementation contexts.

For purposes of this disclosure the word “support” refers to provisioning of functionality, services, or assistance by a computing component or through computing operations within a broader computing system. When a computing component or set of operations supports a specific functionality, it means that it plays a role in enabling or executing that particular aspect of the computing system. This support can manifest in various ways, including the processing of data, execution of operations, management of resources, and ensuring compatibility or interoperability with other components. Additionally, support may involve providing interfaces, APIs (Application Programming Interfaces), or protocols that allow seamless interaction and integration with other elements of the computing system. The concept of support extends beyond mere functionality provision to encompass maintenance, troubleshooting, and the overall optimization of computing resources to ensure the robust and efficient operation of the computing system.

Embodiments of the present technical solution have been described in relation to particular embodiments which are intended in all respects to be illustrative rather than restrictive. Alternative embodiments will become apparent to those of ordinary skill in the art to which the present technical solution pertains without departing from its scope.

From the foregoing, it will be seen that this technical solution is one well adapted to attain all the ends and objects hereinabove set forth together with other advantages which are obvious and which are inherent to the structure.

It will be understood that certain features and sub-combinations are of utility and may be employed without reference to other features or sub-combinations. This is contemplated by and is within the scope of the claims.

What is claimed is:

1. A method, the method comprising:
communicating a data packet, from a Sender artificial intelligence Network Interface Controller (ANC) to a Receiver ANC;
based on communicating the data packet, receiving an acknowledgement packet that indicates a port health status of a first receiver port of a plurality of receiver ports at the Receiver ANC, wherein the port health status indicates that the first receiver port has been deactivated at the Receiver ANC;
based on the port health status indicating that the first receiver port has been deactivated at the Receiver ANC, accessing a Sender Port Status Table that maintains port health statuses associated with the plurality of receiver ports at the Receiver ANC;
updating the Sender Port Status Table with the port health status of the first remote port, wherein the port health status of the first remote port in the Sender Port Status Table indicates that first remote port has been deactivated; and
causing distribution of workloads for the Receiver ANC via a plurality of sender ports of the Sender ANC based on the Sender Port Status Table.

2. The method of claim 1, wherein the Sender ANC and the Receiver ANC operate based on Artificial Intelligence (AI) Transport Layer Protocol (“ATL”) that enables adding a health bit in ATL data and ATL ACK packets.

3. The method of claim 1, wherein the data packet and the acknowledgment packet operate based on a hot-encoded format associated with providing port health status.

4. The method of claim 1, wherein the Sender Port Status Table further maintains port health statuses associated with the plurality of sender ports at the Sender ANC.

5. The method of claim 1, wherein a Receiver Port Status Table maintains port health statuses associated with the plurality of receiver ports and the plurality of sender ports.

6. The method of claim 1, wherein the acknowledgement packet that indicates the port health status that the first receiver port has been deactivated is received based on a Receiver Port Status Table indicating that the first receiver port has been deactivated, wherein the first receiver port is associated with a link status that indicates a link failure condition.

7. The method of claim 1, wherein the Sender ANC and the Receiver ANC are operationally coupled within a single Pod of Devices (POD) or outside a single POD.

8. The method of claim 1, wherein subsequent ACK packets include the port health status of the first receiver port.

9. The method of claim 1, wherein the Sender ANC and the Receiver ANC utilize their corresponding Port Status Table to identify operational ports for communicating workloads.

10. A method, the method comprising:
accessing, at a Receiver artificial intelligence Network Interface Controller (ANC), a link status that indicates a link failure condition associated with a first receiver port of a plurality of receiver ports at the Receiver ANC;
based on the link status, accessing a Receiver ANC Port Status Table that maintains port health status associated with the plurality of receiver ports at the Receiver ANC;
updating the Receiver ANC Port Status Table with a port health status of the first receiver port, wherein the port health status of the first remote port indicates that the first receiver port has been deactivated;
receiving at a Receiver ANC, a data packet from a Sender ANC; and
based on the port health status of the first receiver port and the data packet, communicating, to the Sender ANC, an acknowledgement packet that indicates the port health status of the first receiver port at the Receiver ANC, wherein the acknowledgement packet is communicated to cause the Sender ANC to update a Sender ANC Port Status Table.

11. The method of claim 10, further comprising a link operationally coupled to a link failure detection circuit associated with a register bit for detecting link failure conditions.

12. The method of claim 10, wherein the link failure condition is based on a failed link or a failed port, or a combination of both.

13. The method of claim 10, wherein the acknowledgement packet uses a hot-encoded format to communicate the port health status of the first remote port.

14. The method of claim 10, the method further comprising the Receiver ANC using a local load balancer to distribute acknowledgment packets to the operational ports in the plurality of receiver ports.

15. An artificial intelligence (AI) hardware system comprising:
a Sender AI Network Interface Controller (ANC), the Sender ANC is a multi-port controller operationally coupled to a plurality of sender ports and corresponding links, wherein the Sender ANC maintains a Sender Port Status Table that maintains port health statuses for the plurality of sender ports and a plurality of receiver ports; and
a Receiver ANC, the Receiver ANC is a multi-port controller operationally coupled to the plurality of receiver ports and corresponding links, wherein the Receiver ANC maintains a Receiver Port Status Table that maintains port health statuses for the plurality of receiver ports and the plurality of sender ports.

16. The AI hardware of claim 15, wherein the Sender ANC and the Receiver ANC operate based on an Artificial Intelligence (AI) Transport Layer Protocol (“ATL”) enables adding a health bit in ATL data and ATL ACK packets.

17. The AI hardware of claim 15, wherein the data packet and the acknowledgment packet operate based on a hot-encoded format associated with providing port health status.

18. The AI hardware of claim 15, wherein the Sender ANC and the Receiver ANC are operationally coupled within a single Pod of Devices (POD) or outside a single POD.

19. The AI hardware of claim 15, wherein the Sender ANC and the Receiver ANC utilize their corresponding Port Status Tables to identify operational ports for communicating workloads.

20. The AI hardware of claim 15, wherein the Sender ANC and the Receiver ANC communicate data packets and acknowledgement packets using a hot-encoded format for associated with providing port health status.
